(19) United States
(12) Patent Application Publication
(10) Pub. No.: US 2002/0024531 A1
(43) Pub. Date: Feb. 28, 2002

(54) Method for evaluating employees and aggregating their respective skills and experience in a searchable database for sharing knowledge resources

(76) Inventor: William R. Herrell III, Atlanta, GA (US)

Correspondence Address: CLARK & BRODY, Suite 600, 1750 K Street, NW, Washington, DC, 20006, US

(21) Appl. No.: 09/933,666

(22) Filed: Aug. 22, 2001

Related U.S. Application Data
(60) Provisional application No. 60/228,771, filed on Aug. 30, 2000.

(51) Int. Cl. G06F 7/00

(52) U.S. Cl. 345/700; 705/1

(57) ABSTRACT

A method for evaluating performance of employees includes dynamically capturing their experiences and skill sets in a single format for access by other employees. The method uses a computer or web-based or intranet system for establishing the “value” of an employee through transactions of that employee's stock while also encouraging the employees to complete profiles of themselves listing their work experiences. At least one job performance trait of the employee is identified as part of the transaction, and management can access the traits to aid in employee evaluation.

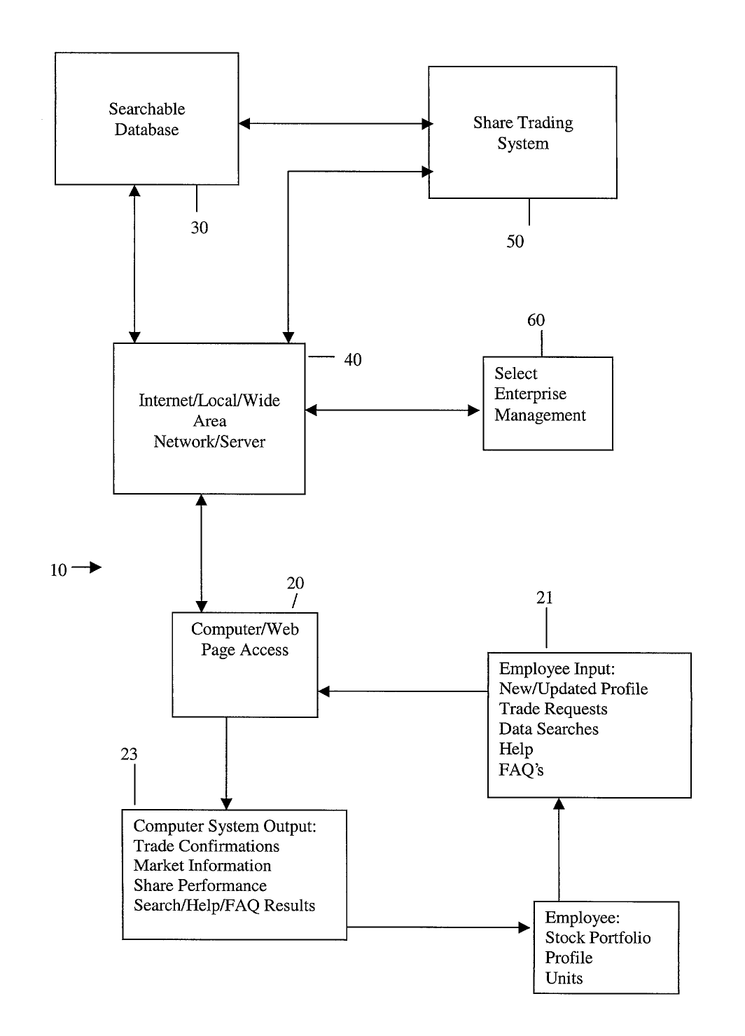

This application claims priority from provisional patent application No. 60/228,771 filed on Aug. 30, 2000.

### TECHNICAL FIELD

This invention relates to the art of systems for evaluating performance of employees and dynamically capturing their experiences and skill sets in a single format for access by other employees. In particular, the invention is a computer or web-based or intranet system for establishing the “value” of an employee through transactions of that employee's stock or representative instrument while also encouraging the employees to complete profiles of themselves listing their work experiences.

### BACKGROUND

Existing evaluation methods and feedback from employees generally take the form of written appraisals processed at a given interval (e.g., quarterly or annually). A superior generally processes the evaluations and feedback as part of a human resource function. Employees and superiors, however, find honest feedback awkward. Superiors find themselves with limited time to fully consider each team member's contribution in light of the administrative burden and the increasing number of direct reports. These evaluation-and-feedback mechanisms have varying degrees of success both for the employee, manager and organization as a whole.

### SUMMARY OF THE INVENTION

In accordance with the invention, a truly dynamic, real-time method of evaluation and feedback provides the employee and his or her superiors with a measure, albeit not absolute, of the employee's perceived value to the organization. One of the best tools for determining value in real time is a dynamic market, such as a stock market. In accordance with the invention, each employee, subordinate or superior in an organization issues “stock” in him/herself to be freely traded by his superiors, peers and subordinates. The stock will have no true monetary value, but the relative value of an individual's stock will be determined by the demand for his stock in the marketplace created by all the employees.

Secondly, yet potentially more valuable to the client organization, each employee will desire to provide the market for his stock with the most current information/profile about him. Therefore, the employees will be motivated to update their profiles frequently to outline their skill sets, work productivity, recent successes, etc. The profile will include information about each employee and his experience in various products, services and industries. The profiles will be maintained in a search-enabled database of profiles, which will become the dynamic, collective knowledge of the organization.

The invention is a tool for real-time, peer-based feedback of an individual's, or team's, performance and value within an organization. Feedback will take the form of peer valuation of the “stock” of the individual or team. Valuation of the “stock” will take place in real time as peers and co-workers trade the “stock” of that individual or team on an Internet-based or networked-based application in accordance with the invention.

Additionally, with the dissemination and flattening of organizations, the updated profile is a way for the employee to communicate involvement to a superior overwhelmed with numerous direct reports. The ability to search that collective database will alone enhance an organization's ability to coordinate its collective knowledge effectively and efficiently.

Each participating individual within a client organization will be required to hold a certain proportion of his “stock” portfolio, respectively, in superiors, peers and subordinates. This provides uniform application of the system. The invention also provides capture of the reasons behind the trades of superiors, peers and subordinates by individual and team, if applicable. In order to capture this additional data, and value, regarding the individual's performance, each trade will require a reason to be given for the trade above and beyond that of the simple performance of the individual's stock. Management may identify key areas to evaluate for each job category or for the firm as a whole (e.g. leadership, revenue generation, analytical ability, teamwork). When a person wishes to execute a trade, he will be prompted to identify one or more of these reasons (job performance traits) for the trade. Several reasons may be chosen in ranked order. Several firewalls will be constructed to ensure the privacy of employee data and some performance measures. It is anticipated that co-workers will be able to review only the employee's profile and the historical performance of their own stock portfolios. The relative transparency of the data will be defined by the client organization. While all data points will be available down to the individual level, that data will be shared only on a selective basis within the client organization (e.g. senior management). The data may be provided on a “no name” basis for aggregation and analysis. The manager of the program will then be able to generate revenue by providing aggregated data analysis by client industry and by specific job function.

The invention allows co-workers to trade the “stock” of their peers in real-time. Employees may have access to an individual's profile, completed and updated by the individual, as well as relative performance measures (i.e. indexing). The initial number of shares “issued” by an individual or team will be determined by the relative size of the organization balanced with the need for a liquid market. Employees will not be able to trade or own their own stock, to maintain the greatest amount of objectivity. The relative price performance of each employee's stock will be determined by the relative demand or lack of demand for his shares. There will be real-time quotes for that individual's stock. Quotes will be generated by a “market maker” function designed to maintain liquidity in the “market” and ensure that prices reflect current demand. The “market maker” will limit attempts to manipulate the market, as by a small, collusive group. This information allows the individual to make trading decisions quickly and easily. This process will be transparent to the client organization.

The invention envisions providing individual performance measures as well as relative price performance (i.e., a beta measure to the overall market, or to the individual's peer group). The trading system implements the “best practices” of the several existing stock trading websites.

Anonymous trades of an employee's peers will determine the marketability and performance of his stock. One way for the individual to market his perceived value is through the timely updating of his profile. The profile will be accessible by anyone in the client organization. The individual may choose to attach a link automatically to his profile at the bottom of each of his e-mails, similar to the manner in which titles and contact information are currently attached. Individuals will want to provide the “market” with timely data on their most recent projects. The resulting real-time update of their profile will provide the overall organization with a comprehensive search-enabled resource for identifying individuals to contact regarding new projects in certain industries or on certain products. Individuals deciding whether or not to purchase an individual stock will be allowed to put stocks on a “watch list” and be prompted by email when that profile has been updated.

The invention will provide a series of easily navigated web pages. The web pages will be accessible by the individuals directly through their desktop computers. The site will be housed on a central server and the site will include a navigation bar linked to (a) a profile page, (b) the search function, (c) trading, (d) portfolio data, (e) indices, (f) FAQs, (g) news, and (h) help function.

Proposed web pages or web page functions are:

(a) The profile page, where the individual can record his or her most recent activity. The invention contemplates that the profile will include performance data on the employee's stock as well as his inputted data regarding work experiences;

(b) A search function that allows searching the collective database by individual, product, service, industry, performance, etc.;

(c) A trading area that is similar in format to known websites for trading stock that will provide access to quotes for individuals, updated “watch” lists, and general performance measures by indices;

(d) Data access by individuals to his or her current portfolio with relevant market position data, performance measures (e.g., year-to-date performance by stock and comparison of performance to indices) and order status;

(e) An indices page that will allow an individual to research indexed data in a time series by job function;

(f) A FAQ area that will allow individuals within client organizations to post questions to the program manager or the system administrator. This area would be client organization specific to allow for detailed questions for that client;

(g) A news area where the program manager can post general news about the product but also provide a mechanism for individual system administrators to post relevant information on their particular company.

(h) A help function that will provide information how to navigate the system as well as information to help a person familiarize himself with trading “stocks”.

The invention entails a method of evaluating employees of an enterprise comprising generating an electronic personal profile for each employee and storing each profile in a database and issuing a number of shares having a unit value for each employee. In conjunction with the electronic personal profile, and issuing a number of shares, a market is established for buying and selling of the shares wherein employees can only buy or sell shares of other employees. As part of each trade, either buying or selling, at least one job performance trait of the employee whose share is being traded is identified for analysis purposes.

In one mode, only a select group or employees or owners such as supervisors can have access to the at least one job performance trait identified so that the information can be used for evaluation purposes and the like. The enterprise can be virtually any group of people working together, such as a company, a number of companies, groups within a company, etc.

The buying and selling can be performed using a global worldwide network or a local area network. In addition, the employees can update their electronic personal profiles to increase the unit value of their shares. The share value can be measured in various units such as currency, or time segments such as vacation time, compensatory time, billable time, non-billable time, sick time, maternity time, and combinations and fractions thereof. Buying and/or selling of shares can be done anonymously. Each employee can have a portfolio of shares comprising shares of at least one employee superior, at least one employee peer, and at least one employee subordinate.

Preferably, the database is searchable to allow employees to search for capabilities of other employees, particularly to obtain help from an employee having special capability as shown by the search.

An employee who may be interested in tracking the development or growth of another employee can create a watch list to identify the other employee so that the watching employee can be notified when the other employee's profile is updated.

When using the internet, each employee has access to the electronic personal profile via a web page. The employee can update the profile as well as monitor share performance; access the market for buying and selling of the shares of other employees, and search the database for access to the electronic personal profile of other employees. The web page can also supply: news related to the enterprise; access to a help program; access to a frequently-asked-question program; and access to indices of data sorted by job function.

The invention also includes a system for evaluating employees of an enterprise comprising a searchable database storing an electronic personal profile of each employee of the enterprise and a number of shares assigned to each employee, and a market trading system accessible by each employee. The market trading system permits shares of each employee to be traded by buying or selling when at least one job performance trait associated with the employee whose share is being traded is identified by the employee requesting the trade. Each employee can access the database and market trading system through a computer and either the internet or a specific type of a network, e.g., either local or wide area.

In one mode, the market trading system requires each trade to be done without revealing the name of the employee trader and generates quotes on shares of the employees based on at least supply and demand for the shares.

### BRIEF DESCRIPTION OF THE DRAWINGS

Reference is made to the sole drawing showing a layout of system components and component functions.

### DETAILED DESCRIPTION OF THE PREFERRED EMBODIMENT

In accordance with a preferred embodiment of the invention, a computer is programmed to provide a searchable database, navigable websites and an automated market maker. This program is made available on the Internet so that a company may use it to provide a market for stock in its employees. As well, the market data for one or a group of organizations may be analyzed to ascertain any of various trends or characteristics.

The preferred operation of the invention proceeds as follows:

1. Access to a central server is programmed on the employee's desktop or such access is granted through the Internet.

2. An employee generates his profile by entering data on a data entry screen.

3. The program stores each profile in a searchable database.

4. The employee issues a specified number of shares in him/herself and receives units in return.

5. The employee uses an on-line trading system that is coupled with an automated market-making program to buy shares in other employees using previously obtained units as payment. Preferably the employee's portfolio of employee stock must contain specified minimum amounts of stock of certain categories of employees, such as supervisors, peers, and subordinates.

6. The employee updates his profile regularly.

7. The employee reviews his portfolio regularly and makes trades based on his perceived value of co-workers to the company. When a trade is made the program records the reasons for the trade in one or more formats, including a multiple-choice format.

8. The employee searches the database to identify co-workers for help on projects (e.g., a deal in the health care industry) and also reviews the stock value of that employee to help assess the employee's capabilities.

9. Supervisors review an employee's stock value and the buy or sell reasons to assist in determining the value of the employee to the company.

Further, the operator of the overall system can use the aggregated data to formulate various reports and to develop industry-wide data.

An exemplary system 10 is depicted in sole FIGURE wherein a computer capable of displaying the web page is designated by the reference numeral 20. The computer 20 receives employee input at 21 which can include search requests, profile updates, trade requests, etc. Computer output 23 provides information to the employee such as updated profiles, information related to the employee's share performance, including individualized as well as information based on search/help requests and FAQ, trading confirmation, etc. The computer is preferably a personal computer.

The computer 20 is linked to the searchable database 30 via a global world wide network, i.e., the internet, or a specific type of network such as a local or wide area network 40 using conventional methodology. The searchable database 30 stores the profiles of the employees, as well as other information that may be of interest to those users of the system.

A trading system 50 is linked to the employees via the internet/network 40 as well as the database 30 for sharing information such as job performance traits received as part of trade requests.

Selected enterprise management of the enterprise are designated by reference numeral 60 and are also in communication with the trading system and database via the internet/local area network 40. Enterprise members are those who can view the job performance traits to better evaluate employees, e.g., supervisors, or other management personnel.

The units to buy and sell shares can be based on currency. For example, an employee will be given so much start money to buy and sell shares. Additional money can be accumulated from profits by trading, or merely adding money to the employee's account via the company or some other regulated method so that all employees are treated fairly.

However, other units can be used such as time, billable hours, vacation days, sick days, compensatory time, or the like, or another type of unit. For example, a unit value may be vacation days, and employee X with 10 vacation days could use three vacation days to obtain a share of employee Y that is valued at 2 vacation days, thereby increasing the value of employee Y. In yet another embodiment, the unit may be product-based such as a car or a fraction thereof. Employees could be given so car fractions of one or more car models, and then trade these fractions in the market system. Different products such as car models could be valued differently to allow for even more variety in the trading process. For example, employee X could have 10 units of car A, which could be twice the value of 10 units of car B. Other unit value systems could be employed as would be within the skill of the artisan.

As such, an invention has been disclosed in terms of preferred embodiments thereof which fulfills each and every one of the objects of the present invention as set forth above and provides a new and improved method for evaluating employees and aggregating their respective skills and experience in a searchable database for sharing knowledge resources within the organization.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A system for evaluating performance of an employee comprising the steps of:
a. issuing shares in each employee, and
b. establishing a market for trading said shares.

2. A system according to claim 1 further comprising the step of providing a searchable database having a profile for each of a number of employees.

3. A method of evaluating employees of an enterprise comprising:
a) generating an electronic personal profile for each employee and storing each profile in a database;
b) issuing a number of shares having a unit value for each employee;
c) establishing a market for buying and selling of the shares wherein employees can only buy or sell shares of other employees; and
d) identifying at least one job performance trait as part of each buying or selling of shares of each employee.

4. The method of claim 3, wherein only a select group or employees or owners has access to the at least one job performance trait identified in step (d).

5. The method of claim 3, wherein the buying and selling is performed using a global worldwide network or a specific area network.

6. The method of claim 3, wherein at least some of the employees update their electronic personal profiles to increase the unit value of their shares.

7. The method of claim 3, wherein the unit value is measured in terms of currency, time, an article, or combinations or fractions thereof.

8. The method of claim 7, wherein time is the unit value, and the time is one of vacation time, compensatory time, billable time, non-billable time, sick time, maternity time, and combinations and fractions thereof.

9. The method of claim 3, wherein buying or selling of shares is done anonymously.

10. The method of claim 3, wherein the database is searchable to allow employees to search for at least capabilities of other employees.

11. The method of claim 3, wherein each employee has a portfolio of shares comprising shares of at least one employee superior, at least one employee poor, and at least one employee subordinate.

12. The method of claim 3, further comprising at least one employee creating a watch list identifying at least one other employee, the one employee being notified when a profile of the at least one other employee is updated.

13. The method of claim 3, further comprising providing a web page accessible for each employee, the web page comprising:
access to the electronic personal profile of the employee for updating, and monitoring of share performance;
access to the market for buying and selling of the shares of other employees, and
search capability to access at least information in the electronic personal profile of other employees.

14. The method of claim 13, wherein the web page further comprises
access to news provided by the enterprise;
access to a help program;
access to a frequently asked question program; and
access to an indices of data sorted by job function.

15. A system for evaluating employees of an enterprise comprising:
a searchable database storing an electronic personal profile of each employee of the enterprise and a number of shares assigned to each employee;
a market trading system accessible by each employee, the market trading system permitting shares of each employee to be traded by buying or selling when at least one job performance trait associated the employee whose share is being traded is identified by the employee requesting the trade; and
a computer allowing each employee access to the searchable database and the market trading system.

16. The system of claim 15, wherein the computer accesses the searchable database and market trading system through one of a global network and a local area network and a server.

17. The system of claim 15, wherein the market trading system requires each trade to be done without revealing the name of the employee trader.

18. The system of claim 15, wherein the market trading system generates quotes on shares of the employees based on at least supply and demand for the shares.
